(19) United States
(12) Patent Application Publication
(10) Pub. No.: US 2025/0223801 A1
(43) Pub. Date: Jul. 10, 2025

(54) EXTERNAL WALLS AND METHODS OF CONSTRUCTING AND CLADDING SAME

(71) Applicant: TIDHAR ECO WALL LTD, Ramat HaSharon (IL)

(72) Inventors: Moshe LAMDAN, Kadima Tzoran (IL); Ariel POKOTINSKY, Ramat HaSharon (IL)

(73) Assignee: TIDHAR ECO WALL LTD, Ramat HaSharon (IL)

(21) Appl. No.: 19/106,647

(22) PCT Filed: May 17, 2022
(86) PCT No.: PCT/IL2022/050515

§ 371 Date: Feb. 26, 2025

(51) Int. Cl. E04B 2/84

(52) U.S. Cl. CPC E04B 2/84

(57) ABSTRACT

Methods of concurrently constructing and cladding concrete walls are disclosed. Methods of securing undercut anchors into the back surface of end-cladding elements are further disclosed. Walls and structures generated thereby are also disclosed.

### RELATED APPLICATION/S

The instant application claim priority under the Paris Convention from Israel Application No. 288212 and Israel Application No. 288213, filed 17 Nov. 2021, the contents of which is hereby incorporated by reference in its entirety.

### FIELD AND BACKGROUND OF THE INVENTION

The present invention, in some embodiments thereof, relates to external concrete walls which are cladded on the interior facing surface and, more particularly, but not exclusively, to external walls which are cladded on both the interior facing surface and the exterior facing surface. Methods of constructing same are also disclosed and in particular methods of simultaneously constructing and cladding concrete walls are disclosed.

A typical building construction involves preparing and constructing walls as well as other building elements at a build site. Additionally or alternatively, a builder may choose to use prefabricated wall modules to construct interior and/or exterior walls of the building.

Once the structural portions of the walls are constructed (i.e., a building envelope is formed), a typical building may incorporate additional features on the walls. For example, the builder may add a cladding layer to the outer surfaces of the building's walls for improved aesthetic appearance as well as weather protection. Similarly, the builder can add a cladding layer to the interior surfaces of the walls. Adding the cladding layer can present particular challenges in construction projects utilizing modular walls, such as structural insulated panels (SIPs) and insulated concrete forms (ICFs), and can be time-consuming and expensive.

There are different wall cladding systems and methods. Gluing is the simplest and cheapest method, and is often used for internal walls. In this method an end-cladding element or material (as these terms are used alternatively throughout), e.g., a ceramic tile, is directly glued onto an existing wall. Whatever the method, attaching cladding to the internal wall is carried out after the wall has been cast and is not carried out concurrently with the casting of the wall itself.

Additionally, a typical building includes various utilities and communications, such as plumbing and sewer lines, electrical lines, data and communication lines, etc. Thus, after constructing the building envelope, the builder may have to furnish the building with necessary utilities. Incorporating various utilities in the building usually presents numerous challenges. For instance, housing utility lines within permanent walls may require modifications and/or partial demolition of already constructed portions of the building envelope, which may be time-consuming and expensive to perform. For example, running electrical, plumbing or other utilities through the SIP panels is time consuming and challenging. The use of ICFs requires careful forethought and placement of utility raceways or connectors, as once the concrete is set it is difficult or impossible to access the wall cavity. Even typical stud framed walls cannot be easily accessed once the drywall is applied, without damaging or replacing the drywall.

Accordingly, there are a number of disadvantages in systems and methods for constructing a building that can be addressed.

Additional background art includes JP2003328532; DE102007060956; and U.S. Pat. No. 5,083,407; Israel Patent Nos. 243159, 288212 and 288213, U.S. Pat. No. 9,670,669, as well as the Israeli standards for building coverings, including, e.g., standard 314—Ceramic tiles definitions and specifications; standard 1555 Part 1—flooring and cladding in porcelain and mosaic outdoor cladding; standard 1555 part 2—flooring and cladding in porcelain and mosaic indoor and closed; standard 1555 part 4—flooring and cladding in porcelain and mosaic dry cladding; standard 1872 part 1—Cladding in artificial stone—definitions; standard 1872 part 2—Cladding in artificial stone—wet cladding; standard 1872 Part 4—Cladding in artificial stone—Gluing with mechanical fixing; standard 1872 part 5.1—Cladding in artificial stone—Precast and mechanical fixing; standard 1872 part 5.2.—Cladding in artificial stone—Toothed units; standard 2378 part 1—Cladding in stone—general demands; standard 2378 part 2—cladding in stone—wet cladding; standard 2378 part 3—cladding in stone—dry cladding; standard 2378 part 4—cladding in stone—gluing with mechanical fixing; standard 2378 part 5—cladding in stone—precast and on site pre casting; standard 2378 part 6—cladding in stone—double wall system; standard 6560—cladding with external thermal barrier; standard 1414part 1—external plastering; standard 1414 part 3—External thermal plastering; and standard 1568—Ventilated facades.

### SUMMARY OF THE INVENTION

According to an aspect of the present invention there is provided a method of securing an undercut anchor in a blind hole which traverses a thickness of an end-cladding element, the blind hole having an opening on a back surface of the end-cladding element, the blind hole being defined by internal walls having a length and a substantially identical diameter along the length, the method comprising:
inserting the undercut anchor into the blind hole;
screwing a flaring element into the undercut anchor, so as to allow the undercut anchor to flare inside the hole and beyond the internal walls of the hole, while compressing material of the end-cladding element surrounding the hole.

According to embodiments of the invention, the end-cladding element is fabricated from a material having a plasticity and being sufficiently non-brittle, so as to allow flaring of the undercut anchor beyond the walls of the hole without breaking the end-cladding element, the material having a retention force that allows rigid attachment of the undercut anchor to the end-cladding element.

According to embodiments of the invention, the flaring element is integrally formed with, or attachable to, an undercut anchor (UA) attaching end of a cementitious material engaging element.

According to embodiments of the invention, the end-cladding element is fabricated from a pre-prefabricated cementitious material.

According to embodiments of the invention, the end-cladding element is a pre-fabricated cement board.

According to embodiments of the invention, the pre-fabricated cement board is a cement bonded particle board or a cement fiber board.

According to an aspect of the present invention there is provided an end-cladding element having a back surface which comprises a blind hole into which an undercut anchor has been flared and secured, the end-cladding element being fabricated from a material, wherein the material of the end-cladding element surrounding the undercut anchor, after the undercut anchor has been flared and secured, is more compressed than the material of the end-cladding element not surrounding the undercut anchor.

According to embodiments of the invention, the material has a plasticity and is sufficiently non-brittle, so as to allow flaring of the undercut anchor into the material without breaking the end-cladding element, the material having a retention force that allows rigid attachment of the undercut anchor to the end-cladding element.

According to embodiments of the invention, the material is a cementitious material.

According to embodiments of the invention, the end-cladding element is a pre-fabricated cement board.

According to embodiments of the invention, the pre-fabricated cement board is a cement bonded particle board or a cement fiber board.

According to an aspect of the present invention there is provided a method of simultaneously constructing a concrete wall and cladding an internal surface of the wall, the method comprising:
(a) providing a first set of end-cladding elements being fabricated from a material for cladding the internal surface;
(b) providing a formwork having an outer sheet and an inner sheet;
(c) arranging the end-cladding elements of the first set with a front surface thereof against a back surface of the inner sheet of the formwork;
(d) connecting cementitious material engaging elements with the end-cladding elements of the first set;
(e) securing the inner sheet and the outer sheet of the formwork to one another with formwork securing elements;
(f) applying the cementitious material into the formwork;
(g) allowing the cementitious material to harden with the cementitious material engaging elements penetrating therein, thereby, simultaneously constructing the concrete wall and cladding an internal surface of the wall.

According to embodiments of the invention, the first set of end-cladding elements are fabricated from a cementitious material.

According to embodiments of the invention, the first set of end-cladding elements comprise pre-fabricated cement boards.

According to embodiments of the invention, the pre-fabricated cement boards are cement bonded particle boards or cement fiber boards.

According to embodiments of the invention, the connecting is via holes that are formed in back surfaces of the first set of end-cladding elements into which undercut anchors have been inserted.

According to embodiments of the invention, the holes are undercut holes.

According to embodiments of the invention, the holes are defined by internal walls having a length and a substantially identical diameter along the length.

According to embodiments of the invention, the connecting is via holes that are formed in sides of the first set of end-cladding elements.

According to embodiments of the invention, the method further comprises mounting, prior to step (e), a layer being of a material that is softer than the end-cladding element, over the end-cladding elements of the first set, such that the cementitious material engaging element traverses and extends beyond a thickness of the layer, and further such that a back surface of the end-cladding element and a front surface of the layer form intimate contact therebetween.

According to embodiments of the invention, the material of the layer is an insulating material.

According to embodiments of the invention, a combined thickness of the layer and the end-cladding element is at least 4.5 cm.

According to embodiments of the invention, the insulating material is a heat insulating material.

According to embodiments of the invention, the material of the layer is polystyrene or Styrofoam.

According to embodiments of the invention, the method further comprises:
(h) arranging a second set of end-cladding elements with a front surface thereof against a back surface of the outer sheet of the formwork; and
(i) connecting cementitious material engaging elements to the end-cladding elements of the second set, wherein steps (h) and (i) are carried out prior to step (e).

According to embodiments of the invention, the method further comprises temporarily securing the first set of end-cladding element to the back surface of an inner sheet of a formwork with a securing plate and a removable end-cladding element securing agent following the arranging and prior to the applying.

According to embodiments of the invention, the method further comprises temporarily securing the second set of end-cladding elements to the back surface of an inner sheet of a formwork with a securing plate and a removable end-cladding element securing agent following the arranging and prior to the applying.

According to embodiments of the invention, the removable end-cladding element securing agent is a metal screw.

According to embodiments of the invention, the method comprises attaching water sealing strips to the back surface of adjacent end-cladding elements prior to the applying.

According to embodiments of the invention, the applying is effected with a concrete pump.

According to embodiments of the invention, the method further comprises ultrasonically vibrating the cementitious material before the cementitious material is hardened.

According to embodiments of the invention, the method further comprises placing a reinforcement metal mesh inside the formwork.

According to embodiments of the invention, the method further comprises removing the formwork.

According to embodiments of the invention, the method further comprises applying at least one finishing material onto cladding elements of the internal surface of the wall.

According to embodiments of the invention, the at least one finishing material is selected from the group consisting of a finishing net, a finishing primer and a finishing paint.

According to an aspect of the present invention there is provided an external concrete wall having an interior-facing surface and an exterior-facing surface, wherein the interior-facing surface is cladded with a plurality of end-cladding elements, wherein a back surface of at least one end-cladding element of the plurality of end-cladding elements comprises a hole into which an undercut anchor has been secured, the undercut anchor being flared and rigidly supported in the hole, wherein the end-cladding element is attached to the inner surface of the concrete wall via a cementitious material engaging element having a cement embedding (CE) end and an undercut anchor attaching (UAA) end, the UAA end being connected to the undercut anchor and the CE end penetrating into the concrete wall.

According to embodiments of the invention, the concrete wall is a fortified concrete wall.

According to embodiments of the invention, the undercut anchor is secured in the hole according to the method described herein.

According to embodiments of the invention, the at least one end-cladding element is fabricated from a cementitious material.

According to embodiments of the invention, the at least one end-cladding element is a pre-fabricated cement board.

According to embodiments of the invention, the at least one end-cladding element is coatable with a finishing material.

According to embodiments of the invention, the external wall is internally coated with a finishing material.

According to embodiments of the invention, the exterior-facing surface of the wall is cladded with a plurality of end-cladding elements.

According to embodiments of the invention, a back surface of the at least one end-cladding element is in intimate contact with the concrete of the concrete wall.

According to embodiments of the invention, the back surface of the at least one end-cladding element is in intimate contact with a layer being of a material that is softer than the end-cladding element, the layer being in intimate contact with the concrete of the concrete wall.

According to embodiments of the invention, the material of the layer is an insulating material.

According to embodiments of the invention, a combined thickness of the layer and the end-cladding element is at least 4.5 cm.

According to embodiments of the invention, the insulating material is a heat insulating material.

According to embodiments of the invention, the material is polystyrene or Styrofoam.

According to an aspect of the present invention there is provided an external concrete wall having an interior-facing surface and an exterior-facing surface, wherein the interior-facing surface is cladded with a plurality of end-cladding elements, wherein back surfaces of the end-cladding elements are lined with a layer being of a material that is softer than the end-cladding elements, the layer being in intimate contact with the concrete of the concrete wall, wherein a combined thickness of the layer and the end-cladding element is at least 4.5 cm.

According to embodiments of the invention, the external wall is a fortified concrete wall.

According to embodiments of the invention, the back surfaces of the end-cladding elements comprise at least one hole into which an undercut anchor has been secured, the undercut anchor being flared and rigidly supported in the hole, wherein the end-cladding element is attached to the second surface via a cementitious material engaging element having a CE end and a UAA end, the CE end penetrating into the concrete of the concrete wall and the UAA end being for connecting to the undercut anchor.

According to embodiments of the invention, the undercut anchor is secured in the hole according to the method described herein.

According to embodiments of the invention, the end-cladding elements are fabricated from a cementitious material.

According to embodiments of the invention, the at least one end-cladding element is a pre-fabricated cement board.

According to embodiments of the invention, the end-cladding element is coatable with a finishing material.

According to embodiments of the invention, the end-cladding element is coated with a finishing material.

According to embodiments of the invention, the exterior facing surface of the wall is cladded with a plurality of end-cladding elements.

According to embodiments of the invention, the material of the layer is an insulating material.

According to embodiments of the invention, the combined thickness of the layer and the end-cladding element is at least 4.5 cm.

According to embodiments of the invention, the insulating material is a heat insulating material.

According to embodiments of the invention, the material is polystyrene or Styrofoam.

According to an aspect of the present invention there is provided an industrial method of constructing an external concrete wall having an interior-facing cladded surface and an exterior-facing cladded surface, the method comprising:
(a) providing a first set of end-cladding elements being formed with holes in back surfaces thereof, the first set of end-cladding elements fabricated from a material for cladding the interior-facing surface of the wall;
(b) providing a second set of end-cladding elements, the second set of end-cladding elements fabricated from a material for cladding the exterior-facing surface of the wall; (c) providing a plurality of kits, each of the kits comprising:
   (i) an undercut anchor configured for being inserted into the holes of end-cladding elements of the first set of end-cladding elements;
   (ii) a cementitious material engaging element which comprises a CE end for embedding into cementitious material of the wall and a UAA end being for connecting to the undercut anchor;
   (iii) a flaring element being firmly connected to, via a distal end thereof, or being integrally formed with, the UAA end of the cementitious material engaging element, the flaring element configured for flaring the undercut anchor in the hole;
(d) providing a formwork having an outer sheet and an inner sheet;
(e) arranging the first set of end-cladding elements with a front surface thereof against a back surface of the inner sheet of the formwork;
(f) arranging the second set of end-cladding elements with a front surface thereof against a back surface of the outer sheet of the formwork;
(g) engaging the plurality of kits in the holes in back surfaces of the first set of cladding elements;
(h) connecting additional cementitious material engaging elements to the second set of end-cladding elements;
(i) securing the inner sheet and the outer sheet of the formwork to one another with formwork securing elements;
(j) applying the cementitious material into the formwork; and
(k) allowing the cementitious material to harden with the cementitious material engaging elements of the kits and the additional cementitious material engaging elements penetrating therein, thereby constructing an external concrete wall having an interior-facing cladded surface and an exterior-facing cladded surface.

According to embodiments of the invention, the additional cementitious material engaging elements are identical to the cementitious material engaging elements of the kits.

According to embodiments of the invention, the second set of end-cladding elements are formed with holes in back surfaces thereof.

According to embodiments of the invention, the first set of end-cladding elements and/or the second set of end-cladding elements are fabricated from a material selected from a cement board, ceramic clay, porcelain, a high pressure laminate (HPL), concrete, Corian®, Caesarstone®, glass, slate and stone.

According to embodiments of the invention, the first set of end-cladding elements are fabricated from a cementitious material.

According to embodiments of the invention, the first set of end-cladding elements are pre-fabricated cement boards.

According to embodiments of the invention, the pre-fabricated cement board is a cement bonded particle board or a cement fiber board.

According to embodiments of the invention, the holes of the first end-cladding elements are undercut holes.

According to embodiments of the invention, each member of the first set of end-cladding elements is fabricated from an identical material.

According to embodiments of the invention, each member of the second set of end-cladding elements is fabricated from an identical material.

According to embodiments of the invention, the method further comprises mounting, prior to step (i), a layer being of a material that is softer than the end-cladding element of the first set, over the end-cladding elements of the first set, such that the cementitious material engaging element traverses and extends beyond a thickness of the layer, and further such that a back surface of the end-cladding element of the first set and a front surface of the layer form intimate contact there between.

According to embodiments of the invention, the material of the layer is an insulating material.

According to embodiments of the invention, a combined thickness of the layer and the end-cladding element is at least 4.5 cm.

According to embodiments of the invention, the insulating material is a heat insulating material.

According to embodiments of the invention, the material of the layer is polystyrene or Styrofoam.

According to embodiments of the invention, the method further comprises temporarily securing the first set of end-cladding elements to the back surface of the inner sheet of the formwork with a securing plate and a removable end-cladding element securing agent following the arranging and prior to the applying.

According to embodiments of the invention, the removable end-cladding element securing agent is a metal screw.

According to embodiments of the invention, the securing plate is not connected to an end-cladding element spacer element or not integral to an end-cladding element spacer element.

According to embodiments of the invention, the method further comprises attaching water sealing strips to the back surface of adjacent end-cladding elements prior to the applying.

According to embodiments of the invention, the applying is effected with a concrete pump.

According to embodiments of the invention, the method further comprises ultrasonically vibrating the cementitious material before the cementitious material is hardened.

According to embodiments of the invention, the arranging comprises spacing the end-cladding elements of the first set of end-cladding elements with spacers spaced on the back surface of the inner sheet of the formwork, wherein the spacers are integral to or permanently attached to the formwork.

According to embodiments of the invention, the arranging comprises spacing the end-cladding elements of the second set of end-cladding elements with spacers spaced on the back surface of the outer sheet of the formwork, wherein the spacers are integral to or permanently attached to the formwork.

According to embodiments of the invention, the method further comprises placing a reinforcement metal mesh inside the formwork.

According to embodiments of the invention, the method further comprises removing the formwork.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A and 1B and 1C are illustrations of three stages in preparation of end-cladding element assemblies with uniform (non-undercut) holes, according to embodiments of the invention;

FIGS. 2A and 2B and 2C are illustrations of three stages in preparation of end-cladding element assemblies with undercut holes, according to embodiments of the invention;

FIG. 3 are illustrations of cladding element assemblies with uniform (non-undercut) holes, according to embodiments of the invention.

FIGS. 4A-C are illustrations of exemplary cementitious material engaging elements (CMEEs) and undercut anchors, according to embodiments of the present invention;

FIG. 5 is an example of exemplary CMEEs, flaring element and undercut anchor accordance with some exemplary embodiments of the invention;

FIGS. 6A-C are different views of an example load dispersion element in accordance of some exemplary embodiments of the invention;

FIGS. 7A-D are illustrations of the steps required to connect a CMEE to a hole on the back surface of an end-cladding element, according to embodiments of the invention.

FIG. 8 is a simplified flow chart of an example method for cladding in accordance with some exemplary embodiments of the invention;

FIGS. 9A-B is an example securing plate assembly in accordance with some exemplary embodiments of the invention;

FIG. 10 is an illustration of a wall which is cladded on the internal-facing surface according to embodiments of the invention;

FIG. 11 is an illustration of a wall which is cladded on both the internal-facing surface and the external-facing surface, according to embodiments of the invention;

FIG. 12 depicting an example outer sheet of a formwork and an example inner sheet of a formwork including end-cladding elements, prior to securing the inner and outer sheets, according with some exemplary embodiments of the invention;

FIG. 13 is a photograph of an example outer sheet and inner of a formwork including end-cladding elements, following securing the inner and outer sheets, according with some exemplary embodiments of the invention;

FIG. 14 is a photograph of a building having a finished internal facing wall, constructed according to embodiments of the invention;

FIG. 15A is a an example profile of a wet cladded wall as depicted in Israel building standard 2378 Part 2;

FIGS. 15B and 15C are respectively a stone facade fixed to a metal formwork prior to casting of the wall and a CMEE according to the Baranovich method.

FIGS. 16A, 16B, 16C and 16D are respectively an alternate example system including an example kit with an example U-shaped element, two perspective views of the example kit and a sectional view of the example kit installed on an edge of an end cladding element, all in accordance with some example embodiments;

FIGS. 17A, 17B and 17C are two perspective views of another example kit with a U-shaped element and a sectional view of the example kit installed on an edge of an end cladding element, all in accordance with some example embodiments; and

FIGS. 18A and 18B are respectively a perspective view and a side view of yet another example kit including a U-shaped piece in accordance with some example embodiments.

### DESCRIPTION OF SPECIFIC EMBODIMENTS OF THE INVENTION

The present invention, in some embodiments thereof, relates to external concrete walls which are cladded on the interior facing surface and, more particularly, but not exclusively, to external walls which are cladded on both the interior facing surface and the exterior facing surface. Methods of constructing same are also disclosed and in particular methods of simultaneously constructing and cladding concrete walls are disclosed.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

In the construction industry, cladding of the external surface of walls may be carried out at the same time that the wall is actually constructed (see for example Israel Patent Nos. 288212 and 288213). The present inventors have now devised a way wherein cladding of the internal surface of walls may also be carried out at the same time that the wall is constructed. In one method, undercut anchors are rigidly attached to the back surface of end-cladding elements (e.g., tiles). These anchors serve as attachments for additional elements necessary to retain the end-cladding element on the concrete wall of the building. The undercut anchors must be sufficiently secured into holes of the end-cladding elements that they remain rigidly attached even during pouring of the concrete when constructing the wall. Surprisingly, the present inventors have found that non-undercut holes (i.e., uniform holes) are sufficient to retain the undercut anchor, provided the material of the end-cladding element is sufficiently non-brittle and plastic.

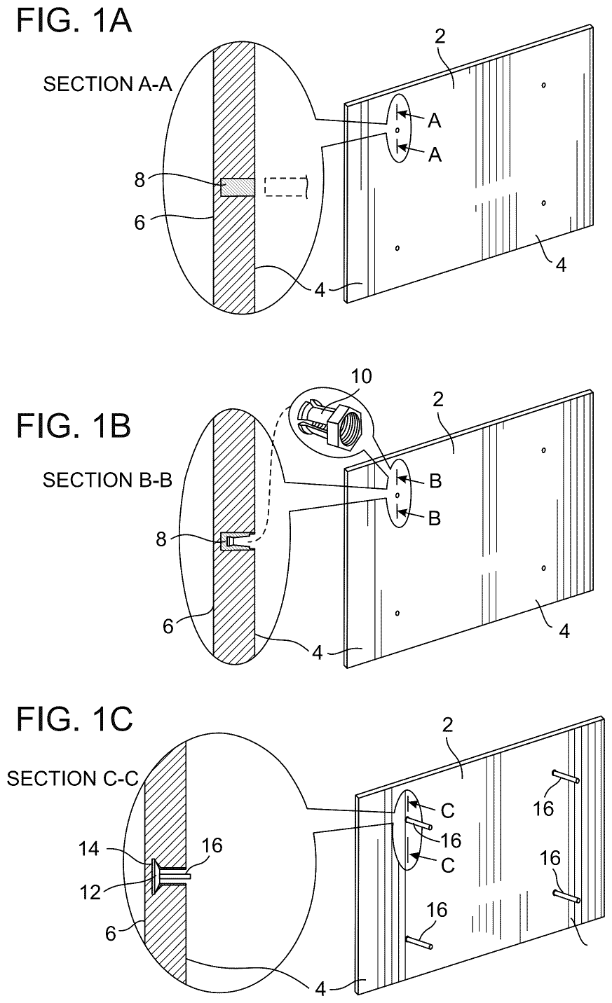

FIGS. 1A-C illustrate how an undercut anchor may be attached to an end-cladding element without the need to drill undercut holes.

FIG. 1A depicts a round, blind hole 8 having an opening on a back surface 4 of an end-cladding element 2. Blind hole 8 is defined by internal walls having a length and a substantially identical diameter along the length. Blind hole 8 does not penetrate the front surface 6 of the end-cladding element 2.

FIG. 1B depicts an unflared undercut anchor 10 partially inserted into a blind hole 8.

FIG. 1C depicts a flared undercut anchor 12 which has now been fully inserted into blind hole 8, following the screwing of a flaring element 16 into undercut anchor 10. The screwing allows undercut anchor 10 to flare inside hole 8 beyond the internal walls of the hole. As the anchor flares, it compresses material of the end-cladding element defining the hole. Thus, the material 14 of the end-cladding element surrounding undercut anchor 12 is more compressed than the material of the end-cladding element not surrounding the undercut anchor. Without being bound to theory, it is believed that the compression of the material around the undercut anchor leads to the enhanced retention force exerted by the end-cladding element on the undercut anchor.

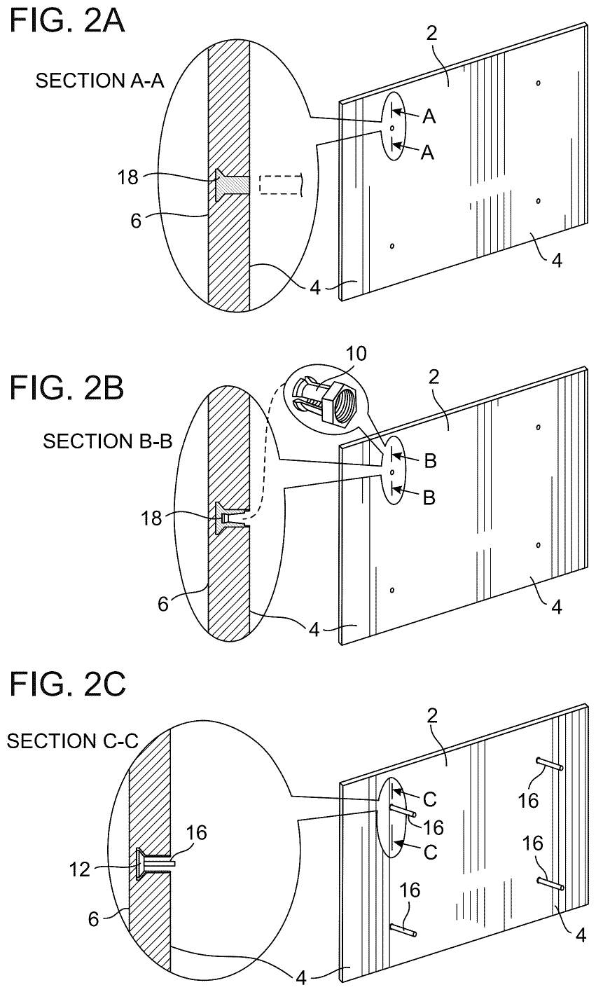

For the sake of comparison, reference is now made to FIGS. 2A-2C which depicts various stages of securing an undercut anchor in an undercut hole which traverses a thickness of an end-cladding element, according to currently known methods.

FIG. 2A depicts undercut hole 18 on a back surface 4 of end-cladding element 2.

FIG. 2B depicts a non-flared undercut anchor 10 partially inserted into undercut hole 18.

FIG. 2C depicts flared undercut anchor 12 which has now been fully inserted into undercut hole 18, following the screwing of flaring element 16 into undercut anchor 10. The screwing allows the undercut anchor to flare inside the hole.

The present method for securing an undercut anchor into an end-cladding element portrayed in FIGS. 1A-C may be summarized as follows:

A method of securing an undercut anchor in a blind hole which traverses a thickness of an end-cladding element, the blind hole having an opening on a back surface of the end-cladding element, the blind hole being defined by internal walls having a length and a substantially identical diameter along the length, the method comprises inserting the undercut anchor into the blind hole; and screwing a flaring element into the undercut anchor, so as to allow the undercut anchor to flare inside the hole and beyond the internal walls of the hole, while compressing material of the end-cladding element surrounding the hole.

According to some exemplary embodiments, the end-cladding elements may be pre-formed with the holes, e.g., during manufacturing or may be drilled following manufacturing. In an exemplary embodiment, the hole is about 5-7 mm in diameter and about 4-7 mm in depth.

According to exemplary embodiments, the end-cladding element is formed with a plurality of holes, e.g., 4-8, 4-12 or 4-50 holes.

Typically, each end-cladding element comprises a plurality of holes—for example at least four, one in each corner, at least 6, at least 8, at least 12. Depending on the size of the end-cladding element more holes may be drilled.

Thus, the present invention provides for an end-cladding element having a back surface which comprises a blind hole into which an undercut anchor has been flared and secured, the end-cladding element being fabricated from a material, wherein the material of the end-cladding element surrounding the undercut anchor, after the undercut anchor has been flared and secured, is more compressed than the material of the end-cladding element not surrounding the undercut anchor.

The end-cladding elements which can be used in the present invention have a wide range of thicknesses less than 3 cm, e.g., 1 cm-3 cm, less than 2 cm, e.g., 1.9 cm, or 1.5 cm or less, or even 9-12 mm. The end-cladding elements may be of any shape (e.g., a polygon, such as rectangular or square; or combination of polygons having, for example, 5 and 6 gons to clad curved surfaces; or a non-polygon) and of any size—e.g., between 20 cm-5 meters in length and between 20 cm to 5 meters in height. According to some exemplary embodiments at least one of the plurality of cladding elements is a quadrangle having X and Y dimensions, whereby both X and Y are each independently greater than 35 cm. The back surface of the end-cladding element may be smooth or rough.

The end-cladding element is fabricated from a material having a plasticity and being sufficiently non-brittle, so as to allow flaring of the undercut anchor into the material without breaking the end-cladding element, the material having a retention force that allows rigid attachment of the undercut anchor to the end-cladding element.

According to a particular embodiment, the end-cladding element is fabricated from a cementitious material, including but not limited to pre-fabricated cement boards (e.g., cement bonded particle board or a cement fiber board),

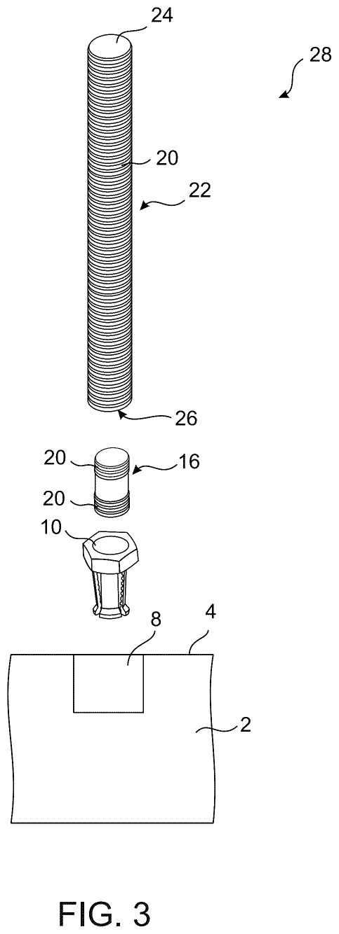

FIG. 3 illustrates an exemplary system 28 for attaching a cementitious material engaging element (CMEE) to an end-cladding element (ECE) according to embodiments of this aspect of the present invention. The system 28 includes CMEE 22, a flaring element 16 and an undercut anchor 10. The flaring element 16 may comprise a threading 20 such that it can screw into a bore of the undercut anchor 10 thereby flaring the anchor in the hole 8. Flaring element 16 may be a screw, bolt, or stud that is configured to flare undercut anchor 10 with a screwing or bolting motion. According to some additional exemplary embodiments, flaring element 16 may be a rod that is configured to flare undercut anchor 10 based on being pushed or hammered into undercut anchor 10.

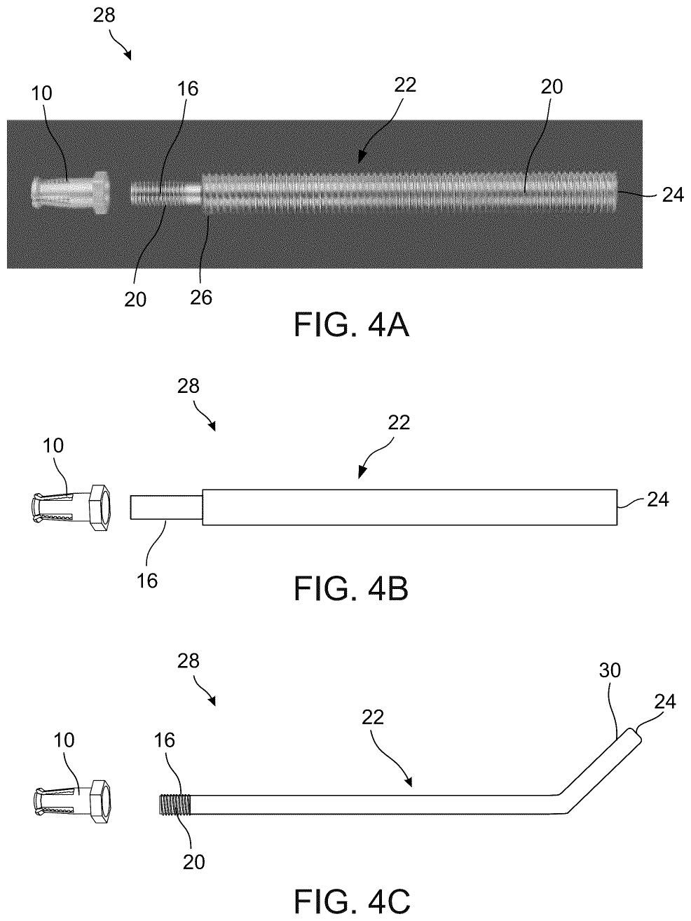

The flaring element 16 may include a threading 20 on one end such that it can be screwed into a bore formed through the undercut anchor (UA) attaching end 26 of a CMEE 22. In another embodiment, the flaring element 16 may be pinned into a bore formed through the UA attaching end 26 of a CMEE 22. In another embodiment, the flaring element 16 is integrally formed with the CMEE 22, as illustrated in FIGS. 4A-C.

The CMEE 22 has an elongated structure, a length, a cement embedding end 24 (also referred to herein as the distal end, since it is the end that is closest to the end-cladding element after the wall is constructed) and an undercut anchor attaching end 26 (also referred to herein as the proximal end, since it is the end furthest from the end-cladding element after the wall is constructed). In one embodiment, the CMEE 22 is a metal pin. According to a particular embodiment, the CMEE 22 has a normal vector component in the cement embedding end 24 which, during service, is positioned parallel to end-cladding element 2.

According to exemplary aspects of some embodiments of the invention, the normal vector component is formed, at least in part, by selecting cement embedding end 24 of the CMEE 22 with a bend. In some exemplary embodiments, system 28 include CMEEs 22 formed with a 90 degree bend. In other exemplary embodiments, illustrated in FIG. 4C, system 28 includes engaging elements 22 with cement embedding end 24 similar to the distal end of engaging elements 22 used in the Baranovich method.

According to exemplary aspects of some embodiments of the invention, the CMEE 22 is threaded at the cement embedding end 24 and wherein the normal vector component is formed at least in part by a threaded surface of the cement embedding end. The threading 20 on the cement embedding end of the CMEE 22 is illustrated in FIG. 3 and FIG. 4A.

The CMEE 22 may be the same or similar to the metal pins described in section 2378 Part 2 of the Israeli building standard, may be the same or similar to the metal pins described in section 2378 Part 5 of the Israeli building standard. In some exemplary embodiments of the invention the engaging element may be formed from a metal such as steel (e.g., a stainless steel rod) that has a diameter of at least 3 mm-4 mm, e.g., 3.5 mm. According to some exemplary embodiments, larger diameter engaging elements may be used. The length of the part of the CMEE that actually engages the cement or concrete may be between 50-100 mm for example, between 60-80 mm.

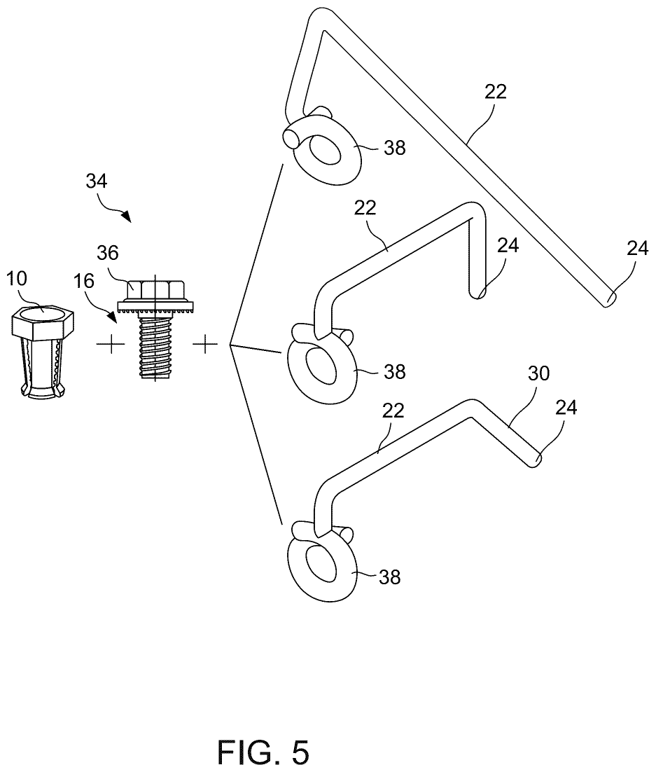

Reference is now made to FIG. 5 which illustrates another exemplary system 34 which can be used to attach a CMEE 22 to an end-cladding element 2 according to this aspect of the invention. According to some exemplary embodiments, system 34 includes an undercut anchor 10 configured to be received in a uniform hole 8 formed on back surface 4 of end-cladding element 2, a flaring element 16 and a CMEE 22. Flaring element 16 may include a first portion 36 of a connecting structure for connecting with a second portion 38 of a connecting structure positioned at the undercut anchor attaching end 26 of the CMEE 22. According to some exemplary embodiments, the connection is defined to be loose so that engaging element 22 can wobble and/or move with respect to flaring element 16. Flaring element 16 may be a screw, bolt, or stud that is configured to flare undercut anchor 10 with a screwing or bolting motion. According to some exemplary embodiments, first portion 36 of the connecting structure is a head of the screw, bolt or stud. The connecting structure comprises first portion 36 of flaring element 16 directly or indirectly connected to second portion 38 of CMEE 22. The tightness or looseness of the connection between the first portion 36 and second portion 38 or the connecting structure (when in service), is physically determined by the relative sizes of the inner portion of the undercut anchor 10, the length of the flaring element 16, the size of the first portion 36, the size of the second portion 38 and the decision of the assembler, as to what tightness or looseness to engage the parts together.

The tightness of the connection between the two can be controlled as further described herein under and in IL Application No. 288213, the contents of which is incorporated herein by reference.

According to some exemplary embodiments, the CMEE 22 includes an undercut anchor attaching end 26 with a connecting element (i.e., a second portion of a connecting structure) 38 and a cement embedding end 24. According to some exemplary embodiments, flaring element 16 may be received through connecting element 38 and may fix connecting element 38 against back surface 4 as flaring element 16 penetrates into undercut anchor 10.

It is noted that FIG. 5 illustrates three different CMEEs 22 with different cement embedding ends 24, either with bends 30 or without.

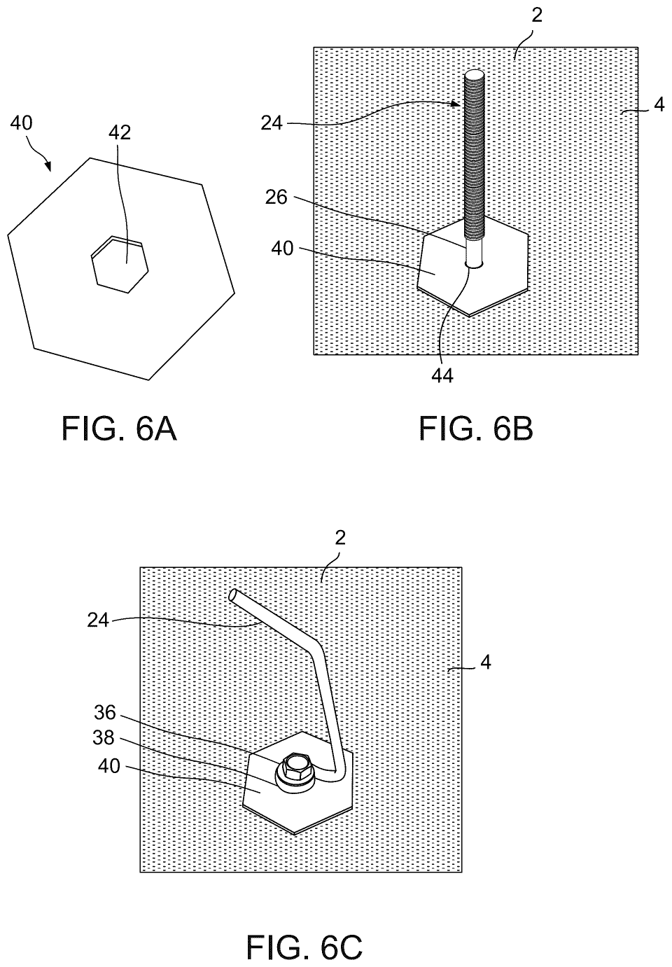

FIGS. 6A, 6B and 6C are different views of an exemplary load dispersion element which may be used when attaching an end-cladding element to a CMEE in accordance with some exemplary embodiments. The load dispersion element may be used when attaching CMEEs depicted in FIGS. 3 and 4A-C (as shown in FIG. 6B) and also of the sort depicted in FIG. 5 (as shown in FIG. 6C).

The load dispersion element 40 may be used to disperse load over a surface area of the load dispersion element 40, so as to reduce load imposed by the flared undercut anchor 12 on walls defining the hole 8 on back surface 4 of end-cladding element 2.

The load dispersion element 40 is connectable to, or integrally formed with, flaring element 16 or undercut anchor 10.

The load dispersion element 40 is placed tightly against back surface 4 of end-cladding element 2 to relieve lateral forces and blows by spreading the force over a larger surface area. The load dispersion element 40 may be a plate and/or a washer that is according to exemplary embodiments made of metal, e.g., steel. According to some exemplary embodiments of the invention, the load dispersion element is about 40 mm in diameter.

According to some exemplary embodiments, load dispersion element 40 is positioned against back surface 4 of an end-cladding element 2 over an undercut anchor 10. According to some exemplary embodiments, load bearing element 40 is a pressure relieving washer including a central bore 42. The load dispersion element 40 is placed over the back surface 4 of the end-cladding element 2 with the central bore 42 positioned over the undercut anchor 10 which has been inserted into the end-cladding element 2. The flaring element 16 (which is attached directly or indirectly to the CMEE 22) is threaded through a nut element 44. Once the flaring element 16 screws into the undercut anchor 10, the nut element 44 can be tightened to secure the load bearing element 40 to the end-cladding element 2. In some exemplary embodiments, central bore 42 has a polygon shape, e.g., pentagonal for receiving nut element 44 and resisting rotation between nut element 44 in bore 42. Load dispersion element 42 is shown to have a pentagonal shape. Other shapes, e.g., rectangular, round, and hexagonal are also contemplated. In some exemplary embodiments, flaring element 16 may penetrate nut element 44 with a threaded engagement. The threaded engagement reinforce the pressure of the load dispersion element 40 against back surface 4 of end-cladding element 2.

As shown in FIG. 6C, load dispersion element 40 may be sandwiched between the first portion of the connecting structure 38 and the back surface 4 of the end-cladding element 2 surrounding the hole 8. According to some exemplary embodiments of the invention, load dispersion element 40 is integrally formed with the first portion of the connecting structure 38 and is pressed against the back surface 4 of the end-cladding element 2 surrounding the hole 8.

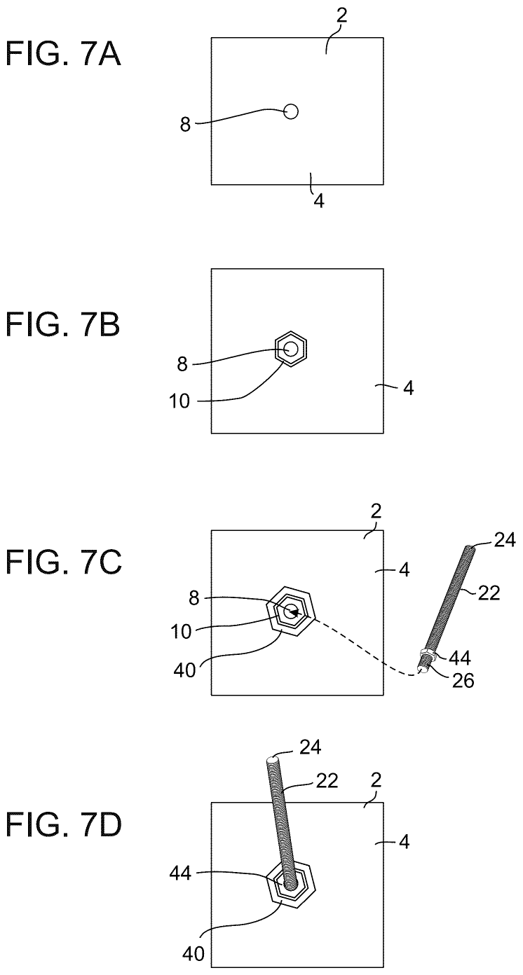

A sequence of actions necessary to connect the CMEE to the end-cladding element according to this aspect of the invention is illustrated in FIGS. 7A-7D. The first step pictured in FIG. 7A shows the back surface 4 of an end-cladding element 2 with a hole 8 drilled within. Next, the undercut anchor 10 is placed in the hole 8, as illustrated in FIG. 7B. Next, the load dispersion element 40 is placed over the undercut anchor 10 such that it is flush with the end-cladding element 2. The CMEE 22 is threaded through the nut element 44 of the dispersion element, as shown in FIG. 7C. Finally, the CMEE 22 is screwed into the undercut anchor, which serves to flare the undercut anchor 10, thereby allowing for a rigid attachment between the CMEE 22 and the end-cladding element 2, as shown in FIG. 7D.

The present inventors have further conceived of a novel method for constructing a concrete wall having an interior facing surface and an exterior facing surface, whereby the constructing is carried out concurrently with cladding of the interior facing surface.

Thus, according to another aspect of the present invention there is provided a method of simultaneously (i.e., concurrently) constructing a concrete wall and cladding an internal surface of said wall, the method comprising:
(a) providing a first set of end-cladding elements being fabricated from a material for cladding said internal surface;
(b) providing a formwork having an outer sheet and an inner sheet;
(c) arranging said end-cladding elements of said first set with a front surface thereof against a back surface of said inner sheet of said formwork;
(d) connecting cementitious material engaging elements (CMEEs) with said end-cladding elements of said first set;
(e) securing said inner sheet and said outer sheet of said formwork to one another with formwork securing elements;
(f) applying said cementitious material into said formwork; and
(g) allowing said cementitious material to harden with said CMEEs penetrating therein.

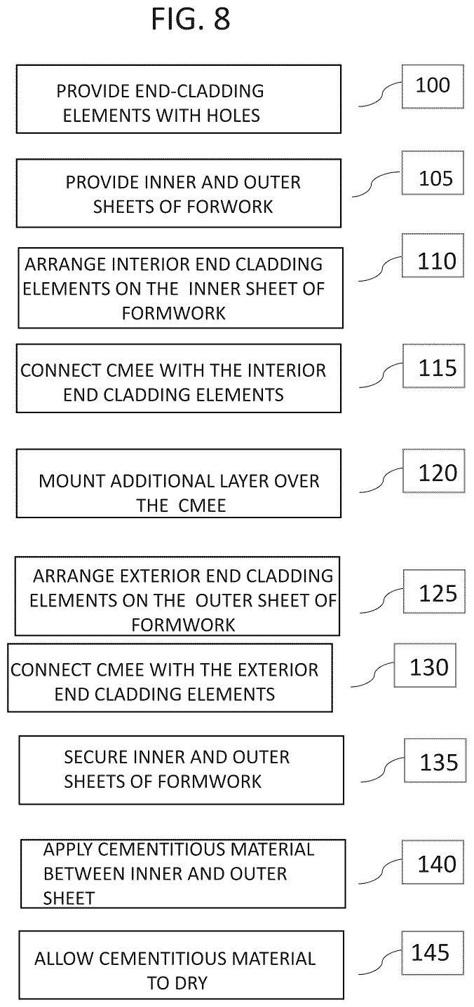

FIG. 8 is a simplified flow chart of the above described method for concurrently constructing and cladding the interior facing surface of a wall in accordance with some exemplary embodiments. According to some exemplary embodiments, the method includes providing a plurality of end-cladding elements with holes (block 100) at a construction site. According to some exemplary embodiments, one or more holes may be formed in the end-cladding elements as needed after receiving the system.

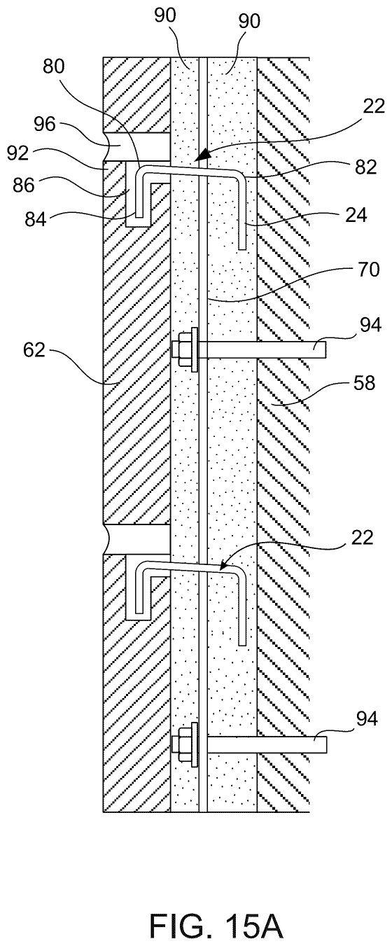

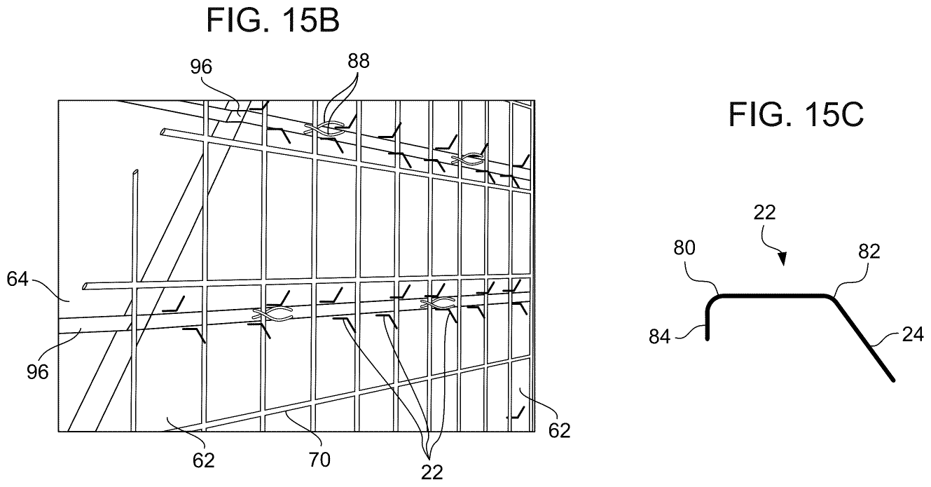

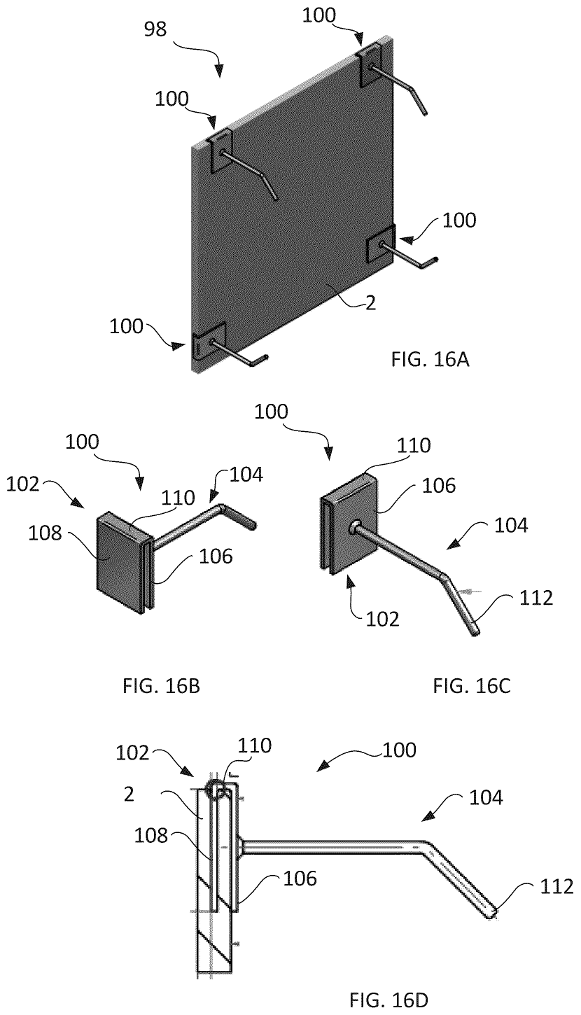

According to a particular embodiment, the hole is an undercut hole (as depicted in FIG. 2A) or a uniform, round blind hole (as depicted in FIG. 1A) in back surfaces of the end-cladding elements. Still alternatively, the holes may be elongated, such as slits or crevices. Alternatively, the holes may be formed in the sides of the end-cladding elements as depicted in FIG. 15A, FIG. 16D or FIG. 17C.

It will be appreciated that when the holes are formed on the back surfaces of the end-cladding elements, undercut anchors are typically screwed into the holes and allowed to flare such that the undercut anchors are rigidly attached to the end-cladding elements (as further described herein above).

One method of constructing a cladded concrete wall using holes formed in the sides of the end-cladding elements is known in the art as the Baranovich method, and will be further described herein below. Another method for constructing a cladded concrete wall using holes formed in the sides of the end-cladding elements is by using a U-shaped element (as further described herein below).

Materials for fabricating end-cladding elements for cladding interior facing walls include but are not limited to plastic (PVC), metal, wood, concrete and stone. Pre-fabricated cladding elements made from cementitious material include pre-fabricated cement boards (e.g. cement bonded particle boards or cement fiber boards).

The end-cladding elements are arranged on the inner sheet of a formwork (block 110). The front surface of the end-cladding elements are arranged on the back surface of the inner sheet of the formwork. According to some exemplary embodiments, the end-cladding elements used to clad the internal facing surface of a wall are not spaced with spacers on the formwork, but are placed in direct contact with one another.

According to some exemplary embodiments, the end-cladding elements are secured against the inner sheet of the formwork with securing plates. According to some exemplary embodiments, the securing plates are arranged on the back surface of the end-cladding elements.

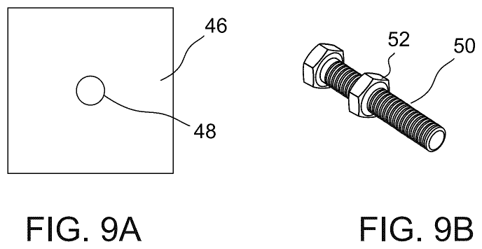

An exemplary securing system is illustrated in FIGS. 9A and 9B. According to some exemplary embodiments, securing plates are rectangular plates 46 with a bore 48 through which a securing element 50 is received. Securing element 50 may extend through an outer sheet of a formwork and may be fixed with a nut element 52 that engages securing element 50 with a threaded connection. According to some exemplary embodiments, the threaded connection resists leakage of cementitious material through bore 48 during casting and thereby provides a cleaner finish. In some exemplary embodiments, the securing plates 50 are used in place of the tying method used in the Baranovich system.

Securing plates 46 may be metal or may be another material that resists rust. According to some exemplary embodiments, securing plates 46 is formed with Delrin®. According to some exemplary embodiments, securing plates 46 are square with a width and height of 30 mm-90 mm, e.g., about 60 mm. According to some exemplary embodiments bore 48 is 5 mm 15 mm, e.g., 7 mm, in diameter.

After casting, securing element 46 is removed to release the inner sheet of formwork and expose the end-cladding elements.

According to exemplary embodiments, CMEEs are then engaged in the holes (block 115). Alternatively, the CMEES may be engaged in the holes of the end-cladding elements prior to arranging (or securing) on the back surface of the inner sheet of the formwork.

Additional layers of material may be juxtaposed over the end-cladding elements so as to increase the thickness of the cladding element (block 120). In one embodiment, the method comprises mounting a layer of a material that is softer than the end-cladding element, over the end-cladding elements, such that the CMEE traverses and extends beyond a thickness of the layer, and further such that a back surface of the end-cladding element and a front surface of the layer form intimate contact there-between.

The mounting may be affected following engagement of the CMEEs into the holes of the end-cladding elements. The mounting may be affected prior to the arranging (or securing) on the inner sheet of the formwork or following the arranging on the inner sheet of the formwork. The additional layer may have holes pre-formed therein which match the spacing of the holes of the end-cladding elements through with the CMEEs protrude. Alternatively, the additional layer may be of a material sufficiently soft that the CMEEs can pierce the layer thereby forming the holes during the mounting itself.

According to a particular embodiment, the material of the layer is an insulating material (e.g. thermal insulating material or an acoustic insulating material).

Examples of insulating materials include, but are not limited to flexible elastomeric foam, polystyrene, polyurethane, polyethylene foam, glass wool, cellulose insulation, and mineral wool. A preferred material is polystyrene or Styrofoam.

In one embodiment, the thickness of the layer is such that the combined thickness of the layer when it is in intimate contact with the end-cladding element is at least 4.5 cm, at least 5 cm or even at least 6 cm.

In another embodiment, the thickness of the layer is about 3.5 cm, 4 cm or even 4.5 cm and the thickness of the end-cladding element is between about 0.9 cm-1.2 cm. In one embodiment, the thickness of the layer serves to house utility lines or communication lines. It will be appreciated that once the concrete of the wall is set it is difficult or impossible to access the wall cavity. Accordingly, the cladded walls described herein are preformed with cavities for such lines.

According to particular embodiments, the method optionally comprises arranging a second set of end-cladding elements (for cladding the exterior facing surface of a wall) with a front surface thereof against a back surface of the outer sheet of the formwork (block 125). It will be appreciated that if the method includes this step, the method can be used for concurrently constructing and cladding the wall on both its internal facing side and its external facing side.

According to some exemplary embodiments, end-cladding elements used for cladding an exterior facing surface of a wall are porcelain or ceramic tiles. Such end-cladding elements may be fabricated from other man-made (i.e., synthetic) materials (such as high pressure laminate (HPL), concrete, Corian®, Caesarstone®), glass, clay, brick or with slate. According to some exemplary embodiments of the invention, the end-cladding element may have a water absorption of less than 0.5%.

CMEEs are connected to holes of the end-cladding elements used for cladding an exterior surface of the wall (block 130). In one embodiment the holes are undercut holes on the back surface of the end-cladding elements. In another embodiment, the holes formed in the sides of the end-cladding elements as depicted in FIGS. 15A, 16D and 17C, as further described herein below.

According to some exemplary embodiments, the end-cladding elements for cladding the exterior facing surface of the wall are spaced with spacers on the outer sheet of the formwork.

According to some exemplary embodiments, the end-cladding elements for cladding the exterior facing surface of a wall are secured against the outer sheet of the formwork with securing plates (as described herein above). According to some exemplary embodiments, the securing plates are secured to the outer sheet of said formwork through the spacers. According to some exemplary embodiments each of the securing plates are arranged on the back surface of the end-cladding elements (over the joining edge of two adjacent end-cladding elements with spacers there-between). According to some exemplary embodiments, the spacers are fixed to the outer sheet of the formwork with a screw thread connection. In some exemplary embodiments, water sealing strips are applied onto back surfaces of the end-cladding elements to cover gaps between the end-cladding elements. The sealing strips may seal the gaps and prevent leakage of the cementitious material onto the front surface of the end-cladding elements and the outer sheet of the formwork. According to some exemplary embodiments, the securing plates are positioned over the sealing strips.

Sealing strips may for example be a gasket. Since there are no pins penetrating the gaps between adjacent end-cladding elements, it is possible to seal the gap with a solid material as opposed to a paste or liquid. The solid sealing may be more robust and may provide superior sealing. According to some exemplary embodiments, the sealing strip is a 1 mm Ethylene Propylene Diene Monomer (EPDM) sheet. EPDM sheets are known to be used to weather-seal roofs and are outdoor and UV rated for over 80 years of use. The sheet may be adhered to edges along the back surface of the end-cladding elements.

Whether or not, the method comprises arranging a second set of end-cladding elements (for cladding the exterior facing surface of a wall), reinforcements may be added to the defined volume, e.g., reinforcement metal bars or metal mesh. According to some exemplary embodiments, the engaging elements penetrate holes of the reinforcement metal mesh and engage with the reinforcement metal mesh.

The inner sheet of the formwork and the outer sheet of the formwork may then be secured to one another to define a volume in which the cementitious material may be received (block 135). According to some exemplary embodiments, the cementitious material is added to the defined volume (block 140) of the framework and allowed to dry (block 145). In some exemplary embodiments, the cementitious material is added with a pump pumping the cementitious material. In some exemplary embodiments, the cementitious material is added through a funnel to reduce the flow rate of the cementitious material within the volume.

After drying of the cementitious material, the framework may be removed. According to some exemplary embodiments, the method includes removing cementitious material leakages from a front surface of end-cladding elements.

Once the internally cladded wall is completed, the wall may be finished by applying at least one finishing material, examples of which include, but are not limited to, a finishing net, a finishing primer and a finishing paint.

According to another aspect of the present invention there is provided an external concrete wall having an interior-facing surface and an exterior-facing surface, wherein said interior-facing surface is cladded with a plurality of end-cladding elements, wherein a back surface of at least one end-cladding element of said plurality of end-cladding elements comprises a hole into which an undercut anchor has been secured, said undercut anchor being flared and rigidly supported in said hole, wherein said end-cladding element is attached to said inner surface of the concrete wall via a CMEE having a cement embedding (CE) end and an undercut anchor attaching (UAA) end, said UAA end being connected to said undercut anchor and said CE end penetrating into the concrete wall.

According to still another aspect of the present invention there is provided an external concrete wall having an interior-facing surface and an exterior-facing surface, wherein the interior-facing surface is cladded with a plurality of end-cladding elements, wherein back surfaces of the end-cladding elements are lined with a layer being of a material that is softer than said end-cladding elements, the layer being in intimate contact with the concrete of the concrete wall, wherein a combined thickness of the layer and the end-cladding element is at least 4.5 cm.

The external concrete wall may be the outer wall of a building (e.g. a house).

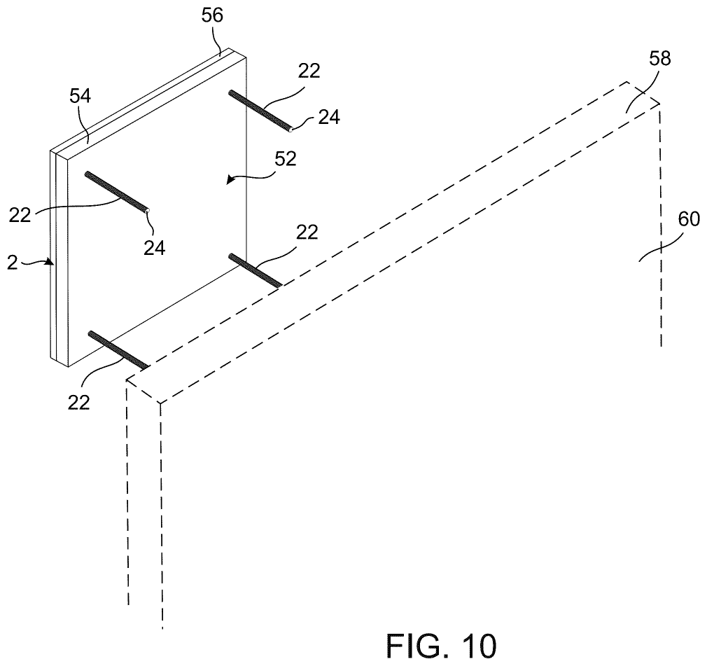

A blown-out wall according to embodiments of this aspect of the invention is illustrated in FIG. 10. Concrete wall 58 has an interior facing surface (not seen) and an exterior facing surface 60. The interior-facing surface is cladded with an end-cladding element 2 which is attached to the interior facing surface of the concrete wall 58 with a CMEE 22. The CMEE 22 has a cement embedding end 24 and an undercut anchor attaching end (not seen in Figure).

According to a particular embodiment, the wall is a fortified concrete wall (i.e. contains metal (e.g. steel bars) within.

In one embodiment, the undercut anchor 10 is secured into an undercut hole 18 made in the end-cladding element 2. In another embodiment, the undercut anchor 10 is secured into a uniform hole 8 made in the end-cladding element 2, as described herein above.

End-cladding element 2 may be fabricated from any material known in the art which are used for cladding. Preferred materials are cementitious materials such as pre-fabricated cement boards, as described herein above. In a particular embodiment, the end-cladding element is fabricated from a material to which a finishing material may be added.

The concrete of the interior facing surface of the concrete wall 58 may be in intimate contact with the back surface 4 of the end-cladding element.

Alternatively, the concrete of the interior facing surface of the concrete wall 58 is in intimate contact with a layer 52 through which CMEE 22 penetrates. Layer 52 and end-cladding element 2 are juxtaposed against each other and are in intimate contact.

Exemplary materials which can be used to fabricate layer 52 include insulating materials, examples of which are provided herein above. Typically, the material is softer than the material used to fabricate the end-cladding element. In one embodiment, it is sufficiently soft that it may be cut to house utility lines after construction of the wall. Layer 52 has a thickness 54 and end-cladding element 2 has a thickness 56. Typically, thickness 54 is greater than thickness 56. According to exemplary embodiments, the combination of thickness 54 and thickness 56 is at least 4.5 cm, at least 5 cm or even at least 6 cm.

As mentioned, as well as the interior facing surface, the exterior-facing surface of the wall may also be cladded.

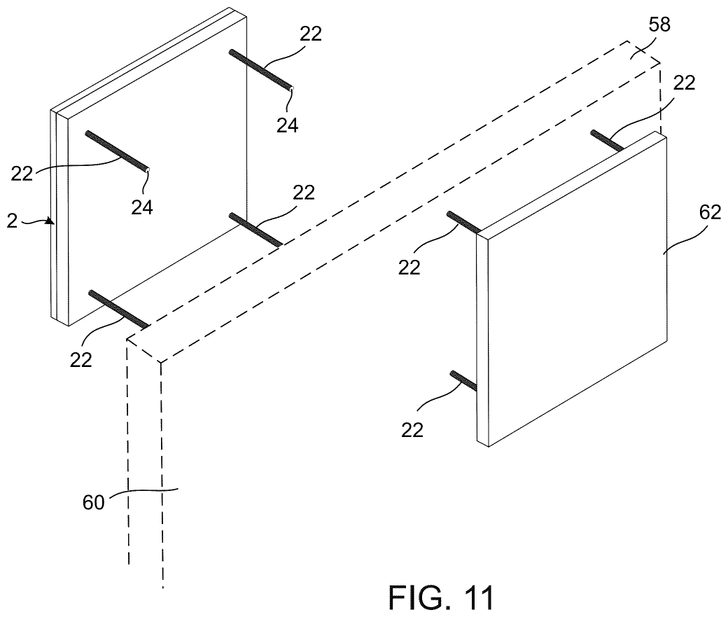

Reference is now made to FIG. 11 which shows a blow-out of a wall being cladded on both the interior and exterior facing surface.

Concrete wall 58 has an interior facing surface (not seen) and an exterior facing surface 60. The interior-facing surface is cladded with an end-cladding element 2 which is attached to the interior facing surface of the concrete wall 58 with a CMEE 22. Concrete wall 58 has an exterior facing surface 60. The exterior-facing surface is cladded with an end-cladding element 62 suitable for exteriors which is attached to the exterior facing surface of the concrete wall 60 with CMEEs 22.

According to another aspect of the present invention there is provided an industrial method of constructing an external concrete wall having an interior-facing cladded surface and an exterior-facing cladded surface, the method comprising:
(a) providing a first set of end-cladding elements being formed with holes in back surfaces thereof, the first set of end-cladding elements fabricated from a material for cladding the interior-facing surface of the wall;
(b) providing a second set of end-cladding elements, the second set of end-cladding elements fabricated from a material for cladding the exterior-facing surface of the wall; (c) providing a plurality of kits, each of the kits comprising:
   (i) an undercut anchor configured for being inserted into the holes of end-cladding elements of the first set of end-cladding elements;
   (ii) a cementitious material engaging element which comprises a CE end for embedding into cementitious material of the wall and a UAA end being for connecting to the undercut anchor;
   (iii) a flaring element being firmly connected to, via a distal end thereof, or being integrally formed with, the UAA end of the cementitious material engaging element, the flaring element configured for flaring the undercut anchor in the hole;
(d) providing a formwork having an outer sheet and an inner sheet;
(e) arranging the first set of end-cladding elements with a front surface thereof against a back surface of the inner sheet of the formwork;
(f) arranging the second set of end-cladding elements with a front surface thereof against a back surface of the outer sheet of the formwork;
(g) engaging the plurality of kits in the holes in back surfaces of the first set of cladding elements;
(h) connecting additional cementitious material engaging elements to the second set of end-cladding elements;
(i) securing the inner sheet and the outer sheet of the formwork to one another with formwork securing elements;
(j) applying the cementitious material into the formwork; and
(k) allowing the cementitious material to harden with the cementitious material engaging elements of the kits and the additional cementitious material engaging elements penetrating therein, thereby constructing an external concrete wall having an interior-facing cladded surface and an exterior-facing cladded surface.

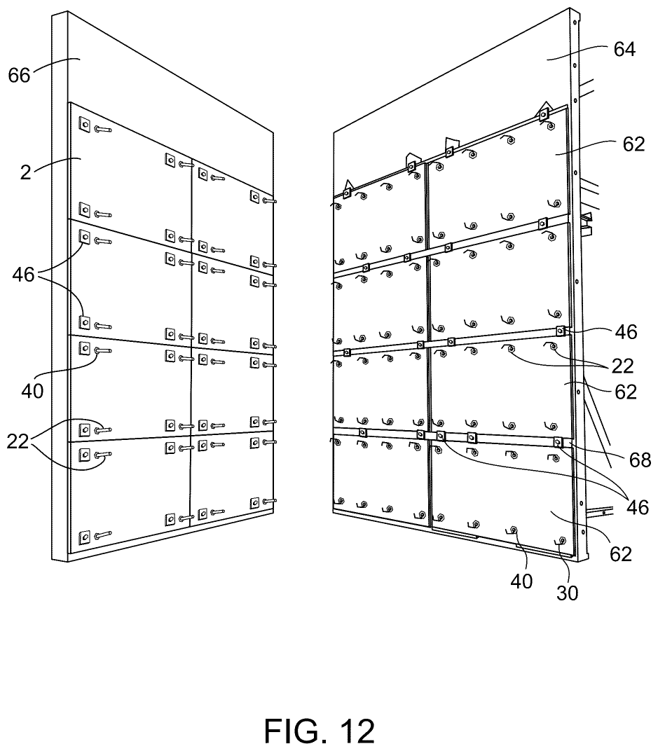

An exemplary set-up showing the organization of the end-cladding elements on the formwork according to embodiments of the method described herein is shown in FIG. 12.

FIG. 12 displays an outer sheet of a formwork 64 and an inner sheet of a formwork 66 before it is secured and the cement is poured within. End-cladding elements 2 are arranged on the back surface of an inner sheet of a formwork 66. End-cladding elements 62 (suitable for cladding the exterior facing surface of the wall) are arranged on the back surface of an outer sheet of a formwork 66. CMEE 22 protrude out of the back surface of the tiles. Back surfaces of end-cladding elements 62 comprise holes 18 into which CMEE 22 are inserted. CMEE may have a bend 30. In some cases, the CMEE may be connected to an undercut hole 18 via a connecting structure 36 and 38. Optionally, a load dispersion element 40 may be placed over an undercut anchor 10 which is inserted in the undercut hole 18. Spaces between the end-cladding elements 62 are sealed using water sealing strips 68. Securing plates 46 may be positioned over the sealing strips 68.

End-cladding elements 2 (suitable for cladding the interior facing surface of the wall) are arranged on the back surface of an inner sheet of a formwork 66. CMEE 22 protrude out of the back surface of the end-cladding elements 2. Optionally, the back surface of the end-cladding elements are lined with a layer 52, having a thickness 54, as further detailed herein above. Back surfaces of end-cladding elements 2 comprise holes 8 into which CMEE 22 are inserted. Optionally, a load dispersion element 40 may be placed over an undercut anchor 10 which is inserted in the hole 8. Securing plates 46 may be positioned on the back surfaces of the end-cladding element 2.

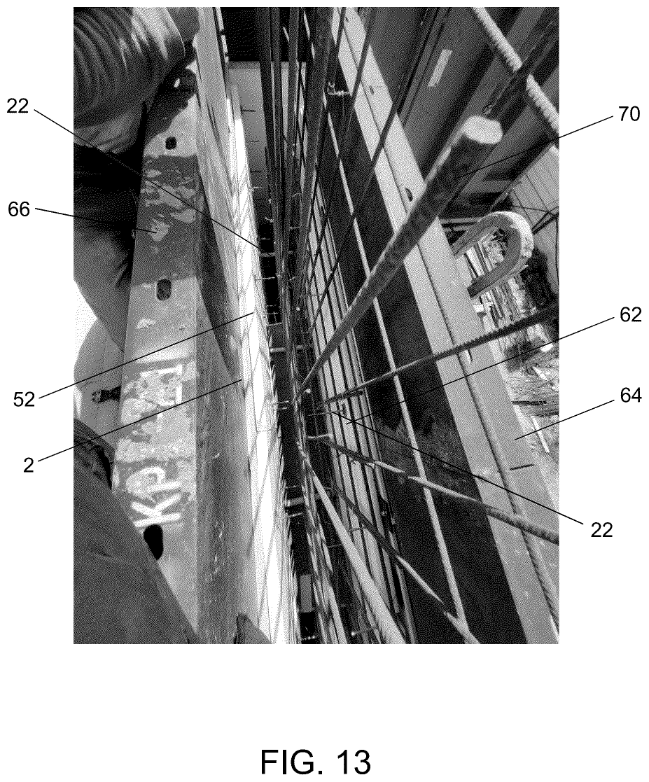

FIG. 13 is a photograph of a top view of an outer sheet of a formwork 64 and an inner sheet of a formwork 66 after they are secured, but before the cement is poured. End-cladding elements 62 (suitable for cladding the exterior facing surface of the wall) are arranged on the back surface of an outer sheet of a formwork 64. Back surfaces of end-cladding elements 62 comprise holes 18 into which CMEE 22 are inserted. End-cladding elements 2 (suitable for cladding the interior facing surface of the wall) are arranged on the back surface of an inner sheet of a formwork 66. CMEE 22 protrude out of the back surface of the end-cladding elements 2. Optionally, the back surface of the end-cladding elements are lined with a layer 52, having a thickness 54.

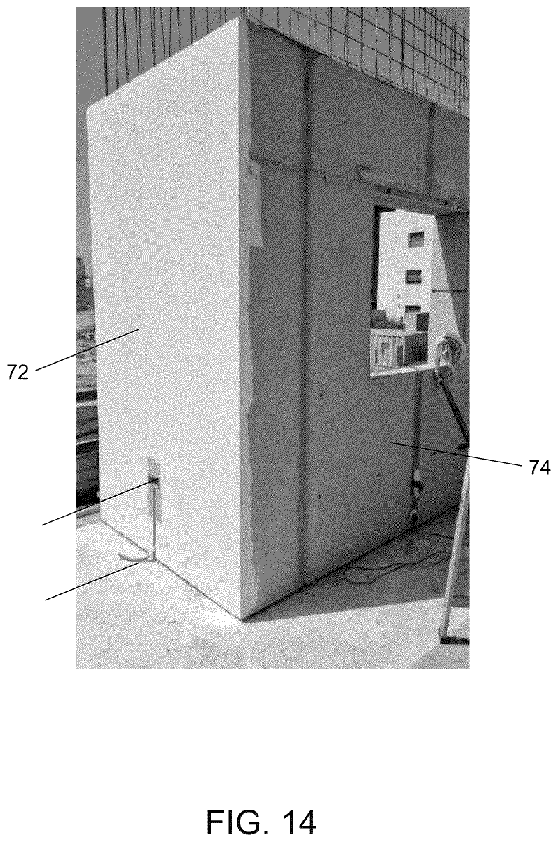

FIG. 14 is a photograph of an interior facing surface of a concrete cladded wall 58. A finished wall 72 and a non-finished wall 74 may be seen. A hole 76 is carved from the layer 52 to make room for utility lines 78 such as plumbing and sewer lines, electrical lines, data and communication.

As mentioned herein above, the present invention also contemplates using the Baranovich method for connecting CMEEs to end-cladding elements. This method will be further described with the aid of FIGS. 15A and 15B.

Reference is now made to FIG. 15A showing an example profile of a cladded wall carried out according to the Baranovich method. FIG. 15A shows a wall 58 cladded with a plurality of end-cladding elements 62. Cladding relies on both chemical bonding (i.e., gluing) end-cladding element 62 to wall 58 with cementitious material 90 and mechanical fixing of end-cladding element 62 to wall 58 with a plurality of engaging elements (e.g., pins) 22. To provide the mechanical fixing with the engaging element 22, a drill hole 86 is first formed through an edge surface 92 of end-cladding element 62 and a reinforcement metal mesh 70 is supported on wall 58 with fixing element 94. Engaging element 22 is typically formed with a first bend 80 and a second bend 82. First bend 80 provides receiving hole attaching end 84 into drill hole 86 and second bend 82 provides folding or hooking a distal end of engaging element 22 onto reinforcement metal mesh 70. Engaging element 22 is fixed onto reinforcement metal mesh 70 while cementitious material 90 is wet and is an integral part of cementitious material 90 when cementitious material 90 hardens. Hole-attaching end 84 of engaging elements 22 may be received through upper, side and lower edges surfaces of end-cladding element 62. Mortar 96 is typically used to fill gaps between end-cladding elements 62.

Reference is now made to FIG. 15B showing a back side of stone facade fixed to a metal formwork 64 prior to casting of the wall according to the Baranovich method, an example profile of a wet cladded wall and an example metal engaging element (i.e., pin) according the Baranovich method. In the Baranovich method described in Israeli building standard 2378 part 5, end-cladding elements 62 are arranged on a first (outer) metal formwork 64 prior to casting exterior wall 58. CMEEs 22 are positioned in drill holes formed through edge surfaces of end-cladding elements 62. Each end-cladding element 62 typically includes four engaging elements 22. Engaging elements 22 typically include a first bend 80 and a second bend 82. Proximal end 84 is inserted into a drill hole 86 inserted into thickness of end-cladding element 62. Second bend 82 is a bend with an obtuse angle. Distal end 24 is not required to physically engage reinforcement metal bars 70 but rather provides for improved anchoring of engaging element 22 into cementitious material once hardened and dried. Gaps between end-cladding elements 62 are sealed with mortar (known as “chochla”) 14 on formwork 64. Reinforcement metal bars (mesh) 70 is then positioned to face the back-surface of end-cladding elements 62 leaving gaps through which the distal ends 24 of engaging elements 22 penetrate. Ties 88 are typically used to temporarily tie formwork 64 to reinforcement metal mesh 70, thereby securing end-cladding elements 62 to formwork 64.

As mentioned herein above, the present invention also contemplates using U-shaped elements for connecting CMEEs to end-cladding elements. The end-cladding elements must be sufficiently thick and non-brittle so as to allow drilling of side holes therein. This method will be further described with the aid of FIGS. 16A-D, 17A-C and 18A-B.

FIGS. 16A, 16B, 16C and 16D are respectively an alternate example system including an example kit with an example U-shaped element, two perspective views of the example kit and a sectional view of the example kit installed on an edge of an end cladding element, all in accordance with some example embodiments. According to some example embodiments, a system 98 includes an end cladding element 2 (or 62) and one or more end cladding kits 100. According to some example embodiments, kit 100 includes a U-shaped element 102 and a cementitious material engaging element (e.g. pin) 104 extending out from U-shaped element 102. U-shaped element is formed with a first wall 106, a second wall 108 spaced from first wall 106 and a base 110 extending from first wall 106 to second wall 108. According to some example embodiments, cementitious material engaging element 104 extends out from first wall 106 in a substantially normal direction. A distal end of cementitious material engaging element 104 may include cement anchoring element 112. According to some example embodiments, second wall 108 is configured to be received within a slot formed through an edge surface of end cladding element 2 (or 62).

FIGS. 17A, 17B and 17C are two perspective views of another example kit with a U-shaped element and a sectional view of the example kit installed on an edge of an end cladding element, all in accordance with some example embodiments. In some example embodiments, second wall 108 of U-shaped element 102 may be shorter than first wall 106 and/or otherwise shaped. Optionally, second wall 108 includes a curved shape to match a shape of a slot cut through an edge surface of end cladding element through which second wall 108 is to be received.

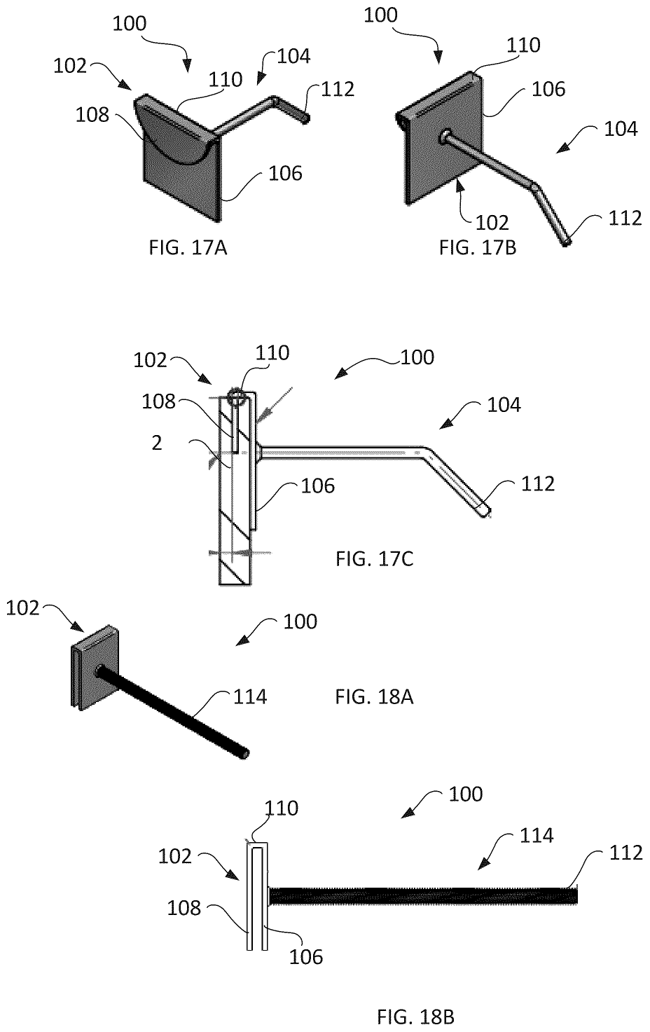

FIGS. 18A and 18B are respectively a perspective view and a side view of yet another example kit including a U-shaped element in accordance with some example embodiments. In some example embodiments, kit 100 includes a stud pin 114 (which serves as a cementitious material engaging element) with screw threads that extend to cement anchoring element 112 at a distal end. In other example embodiments, the screw threads do not extend into cement anchoring element 112. Stud pin 114 may be fixed onto U-shaped element 102 based on welding or with a screw type connection.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there-between.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

In addition, any priority document(s) of this application is/are hereby incorporated herein by reference in its/their entirety.

1-11. (canceled)

12. A method of simultaneously constructing a concrete wall and cladding an internal surface of said wall, the method comprising:
(a) providing a first set of end-cladding elements being fabricated from a material for cladding said internal surface;
(b) providing a formwork having an outer sheet and an inner sheet;
(c) arranging said end-cladding elements of said first set with a front surface thereof against a back surface of said inner sheet of said formwork;
(d) connecting cementitious material engaging elements with said end-cladding elements of said first set;
(e) securing said inner sheet and said outer sheet of said formwork to one another with formwork securing elements;
(f) applying said cementitious material into said formwork;
(g) allowing said cementitious material to harden with said cementitious material engaging elements penetrating therein, thereby, simultaneously constructing the concrete wall and cladding an internal surface of said wall.

13. The method of claim 12, wherein said first set of end-cladding elements are fabricated from a cementitious material.

14. The method of claim 13, wherein said first set of end-cladding elements comprise pre-fabricated cement boards.

15. (canceled)

16. The method of claim 12, wherein said connecting is via holes that are formed in back surfaces of said first set of end-cladding elements into which undercut anchors have been inserted, wherein said holes are undercut holes or wherein said holes are defined by internal walls having a length and a substantially identical diameter along said length.

17-19. (canceled)

20. The method of claim 12, further comprising mounting, prior to step (e), a layer being of a material that is softer than said end-cladding element, over said end-cladding elements of said first set, such that said cementitious material engaging element traverses and extends beyond a thickness of said layer, and further such that a back surface of said end-cladding element and a front surface of said layer form intimate contact therebetween.

21. The method of claim 20, wherein said material of said layer is an insulating material.

22. The method of claim 20, wherein a combined thickness of said layer and said end-cladding element is at least 4.5 cm.

23. (canceled)

24. The method of claim 20, wherein said material of said layer is polystyrene or Styrofoam.

25. The method of claim 12, further comprising:
(h) arranging a second set of end-cladding elements with a front surface thereof against a back surface of said outer sheet of said formwork; and
(i) connecting cementitious material engaging elements to said end-cladding elements of said second set, wherein steps (h) and (i) are carried out prior to step (e).

26. The method of claim 12, further comprising temporarily securing said first set of end-cladding element to said back surface of an inner sheet of a formwork with a securing plate and a removable end-cladding element securing agent following said arranging and prior to said applying.

27. The method of claim 25, further comprising temporarily securing said second set of end-cladding elements to said back surface of an inner sheet of a formwork with a securing plate and a removable end-cladding element securing agent following said arranging and prior to said applying.

28-31. (canceled)

32. The method of claim 12, further comprising placing a reinforcement metal mesh inside said formwork.

33. The method of claim 12, further comprising removing said formwork.

34. The method of claim 33, further comprising applying at least one finishing material onto cladding elements of said internal surface of said wall.

35. The method of claim 34, wherein said at least one finishing material is selected from the group consisting of a finishing net, a finishing primer and a finishing paint.

36. An external concrete wall having an interior-facing surface and an exterior-facing surface, wherein said interior-facing surface is cladded with a plurality of end-cladding elements, wherein a back surface of at least one end-cladding element of said plurality of end-cladding elements comprises a hole into which an undercut anchor has been secured, said undercut anchor being flared and rigidly supported in said hole, wherein said end-cladding element is attached to said inner surface of the concrete wall via a cementitious material engaging element having a cement embedding (CE) end and an undercut anchor attaching (UAA) end, said UAA end being connected to said undercut anchor and said CE end penetrating into the concrete wall.

37. The external concrete wall of claim 36, being a fortified concrete wall.

38. The external concrete wall of claim 36, being constructed according to a method comprising:
(a) providing a first set of end-cladding elements being fabricated from a material for cladding said internal surface;
(b) providing a formwork having an outer sheet and an inner sheet;
(c) arranging said end-cladding elements of said first set with a front surface thereof against a back surface of said inner sheet of said formwork;
(d) connecting cementitious material engaging elements with said end-cladding elements of said first set;
(e) securing said inner sheet and said outer sheet of said formwork to one another with formwork securing elements;
(f) applying said cementitious material into said formwork;
(g) allowing said cementitious material to harden with said cementitious material engaging elements penetrating therein.

39-49. (canceled)

50. An external concrete wall having an interior-facing surface and an exterior-facing surface, wherein said interior-facing surface is cladded with a plurality of end-cladding elements, wherein back surfaces of said end-cladding elements are lined with a layer being of a material that is softer than said end-cladding elements, said layer being in intimate contact with the concrete of the concrete wall, wherein a combined thickness of said layer and said end-cladding element is at least 4.5 cm.

51-62. (canceled)

63. An industrial method of constructing an external concrete wall having an interior-facing cladded surface and an exterior-facing cladded surface, the method comprising:
(a) providing a first set of end-cladding elements being formed with holes in back surfaces thereof, said first set of end-cladding elements fabricated from a material for cladding said interior-facing surface of the wall;
(b) providing a second set of end-cladding elements, said second set of end-cladding elements fabricated from a material for cladding said exterior-facing surface of the wall;
(c) providing a plurality of kits, each of said kits comprising:
(i) an undercut anchor configured for being inserted into said holes of end-cladding elements of said first set of end-cladding elements;
(ii) a cementitious material engaging element which comprises a CE end for embedding into cementitious material of said wall and a UAA end being for connecting to said undercut anchor;
(iii) a flaring element being firmly connected to, via a distal end thereof, or being integrally formed with, said UAA end of said cementitious material engaging element, said flaring element configured for flaring said undercut anchor in said hole;
(d) providing a formwork having an outer sheet and an inner sheet;
(e) arranging said first set of end-cladding elements with a front surface thereof against a back surface of said inner sheet of said formwork;
(f) arranging said second set of end-cladding elements with a front surface thereof against a back surface of said outer sheet of said formwork;
(g) engaging said plurality of kits in said holes in back surfaces of said first set of cladding elements;
(h) connecting additional cementitious material engaging elements to said second set of end-cladding elements;
(i) securing said inner sheet and said outer sheet of said formwork to one another with formwork securing elements;
(j) applying said cementitious material into said formwork; and
(k) allowing said cementitious material to harden with said cementitious material engaging elements of said kits and said additional cementitious material engaging elements penetrating therein, thereby constructing an external concrete wall having an interior-facing cladded surface and an exterior-facing cladded surface.

64-87. (canceled)
